(19) United States
(12) Patent Application Publication
(10) Pub. No.: US 2025/0192626 A1
(43) Pub. Date: Jun. 12, 2025

(54) ELECTRIC MOTOR STATOR TOOTH COOLING

(71) Applicant: GM GLOBAL TECHNOLOGY OPERATIONS LLC, Detroil, MI (US)

(72) Inventors: Alireza Fatemi, Canton, MI (US); Peng Peng, Columbus, OH (US); Xiaofeng Yang, Troy, MI (US); Thomas W. Nehl, Shelby Township, MI (US); Gokhan Cakal, Madison, WI (US)

(73) Assignee: GM GLOBAL TECHNOLOGY OPERATIONS LLC, Detroit, MI (US)

(21) Appl. No.: 18/532,644

(22) Filed: Dec. 7, 2023

(51) Int. Cl. H02K 1/20; H02K 1/16

(52) U.S. Cl. CPC H02K 1/20; H02K 1/16

(57) ABSTRACT

An electric motor includes a stator having a stator core constructed from a ferromagnetic material and having an external stator surface. The stator core includes a stator core body and a plurality of stator teeth extending therefrom and the plurality of stator teeth define conductor slots therebetween. The electric motor also includes at least one rotor, each having an external rotor surface, a plurality of magnetic poles, and configured to rotate relative to the stator about a rotational axis. The stator also includes a plurality of stator conductors arranged within the conductor slots and configured to establish a rotating magnetic field exerting a torque on the rotor(s) via interaction with the magnetic poles. The stator additionally includes a plurality of first cooling channels, each defined by a respective stator tooth and configured to receive and pass therethrough a fluid to cool the corresponding stator tooth.

### INTRODUCTION

The disclosure relates to an electric motor stator with cooled teeth.

An electric motor is a machine that converts electric energy into mechanical energy. Electric motors may be configured as an alternating current (AC) or a direct current (DC) type. An electric motor's operation is based on an electromagnetic interaction between permanent magnets and the magnetic field created by the machine's selectively energized coils. Electric motors are classified into two categories based on the direction of the magnetic field-axial flux motors and radial flux motors.

As a byproduct of generated torque, electric motors produce thermal energy which may adversely affect motor performance and reliability. Cooling of an electric motor may therefore remove thermal stress seen by motor poles or windings and provide longer motor life under or close to peak load. Additionally, electric motor cooling may generally quiet motor operation and enhance motor operation at higher speeds, as well as facilitate reduced motor inertia and packaging.

### SUMMARY

An electric motor includes a stator having a stator core constructed from a ferromagnetic material and having an external stator surface. The stator core includes a stator core body and a plurality of stator teeth extending therefrom and the plurality of stator teeth define conductor slots therebetween. The electric motor also includes at least one rotor, each having an external rotor surface, a plurality of magnetic poles, and configured to rotate relative to the stator about a rotational axis. The stator also includes a plurality of stator conductors arranged within the conductor slots and configured to establish a rotating magnetic field exerting a torque on the rotor(s) via interaction with the magnetic poles. The stator additionally includes a plurality of first cooling channels, each defined by a respective stator tooth and configured to receive and pass therethrough a fluid to cool the corresponding stator tooth.

The stator core may include a plurality of adjacent stator laminations arranged along the rotational axis. Each stator tooth may be assembled from the plurality of laminations and each first cooling channel may extend along the rotational axis.

The stator may additionally include a plurality of radial cross-channels arranged within the stator core orthogonally to the plurality of first cooling channels. In such an embodiment, each of the plurality of radial cross-channels may be configured to feed the fluid to a respective first cooling channel.

The stator may additionally include at least one second cooling channel defined by the stator core body. The second cooling channel(s) may be arranged along the rotational axis radially outward with respect to the plurality of first cooling channels and be in fluid communication with the plurality of radial cross-channels.

In a cross-sectional view, each stator tooth may include a relatively thinner first section projecting directly from the stator core body and a relatively thicker second section extending from the first section. In such an embodiment, each first cooling channel may be defined by a respective first section of the corresponding stator tooth.

Each stator conductor arranged within a respective conductor slot between corresponding first sections of neighboring stator teeth may have a relatively larger width and each stator conductor arranged within a respective conductor slot between corresponding second sections of neighboring stator teeth may have a relatively smaller width.

The stator conductors arranged between the first sections and the stator conductors arranged between the second sections of neighboring stator teeth may have different aspect ratios but equivalent cross-sectional areas.

The second section of each stator tooth may have a T-shaped end configured to retain respective stator conductors within the corresponding conductor slot.

The electric motor may have a radial flux construction having a single rotor mounted inside the stator. The external stator surface stator may be a radially inner stator surface. The external rotor surface may be a radially outer rotor surface. An airgap may be established between the radially inner stator surface and the radially outer rotor surface.

The electric motor may additionally include a fluid dam mounted to the radially inner stator surface, fluidly connected to at least one of the plurality of first cooling channels, and configured to direct the fluid exiting the at least one of the plurality of first cooling channels away from the airgap.

The stator may additionally include slot liners arranged between the conductors and the respective neighboring teeth. The slot liners may have a two-piece construction with different thicknesses, wherein individual slot liners are arranged proximate first sections and other slot liners are arranged proximate second sections of neighboring stator teeth. The slot liners arranged between proximate the first sections may be thicker than the slot liners arranged proximate the second sections.

The electric motor may have an axial flux construction, wherein the at least one rotor includes two rotors, each arranged on one side of the stator.

A motor vehicle having such an electric motor as described above is also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic illustration of a motor vehicle having a powertrain employing an electric motor-generator for propulsion.

FIG. 2 is a schematic close-up partial cut-away perspective view of a radial flux embodiment of the electric motor-generator shown in FIG. 1, depicting a stator constructed from multiple adjacent rotor laminations defining stator teeth, and having first cooling channels arranged therein, according to the disclosure.

FIG. 3 is a schematic partial front view of an embodiment of the electric motor-generator shown in FIG. 2, illustrating stator teeth having different thickness sections and variable aspect ratio conductors arranged therebetween, according to an embodiment of the disclosure.

FIG. 4 is a schematic front view of an embodiment of the stator shown in FIG. 2, illustrating stator teeth having T-shaped ends and two-piece slot liners arranged between individual teeth, according to an embodiment of the disclosure.

FIG. 5 is a schematic close-up cross-sectional side view of the radial flux motor-generator shown in FIG. 2, depicting a fluid circulation arrangement including fluid channels extending into the stator teeth and a fluid dam mounted to the stator, according to the disclosure.

### DETAILED DESCRIPTION

Embodiments of the present disclosure as described herein are intended to serve as examples. Other embodiments may take various and alternative forms. Additionally, the drawings are generally schematic and not necessarily to scale. Some features may be exaggerated or minimized to show details of particular components. Therefore, specific structural and functional details disclosed herein are not to be interpreted as limiting, but merely as a representative basis for teaching one skilled in the art to variously employ the present disclosure.

Certain terminology may be used in the following description for the purpose of reference only, and thus are not intended to be limiting. For example, terms such as “above” and “below” refer to directions in the drawings to which reference is made. Terms such as “front”, “back”, “fore”, “aft”, “left”, “right”, “rear”, “side”, “upward”, “downward”, “top”, and “bottom”, etc., describe the orientation and/or location of portions of the components or elements within a consistent but arbitrary frame of reference, which is made clear by reference to the text and the associated drawings describing the components or elements under discussion.

Furthermore, terms such as “first”, “second”, “third”, and so on may be used to describe separate components. Such terminology may include the words specifically mentioned above, derivatives thereof, and words of similar import, and are used descriptively for the figures, and do not represent limitations on the scope of the disclosure, as defined by the appended claims. Moreover, the teachings may be described herein in terms of functional and/or logical block components and/or various processing steps. It should be realized that such block components may include a number of hardware, software, and/or firmware components configured to perform the specified functions.

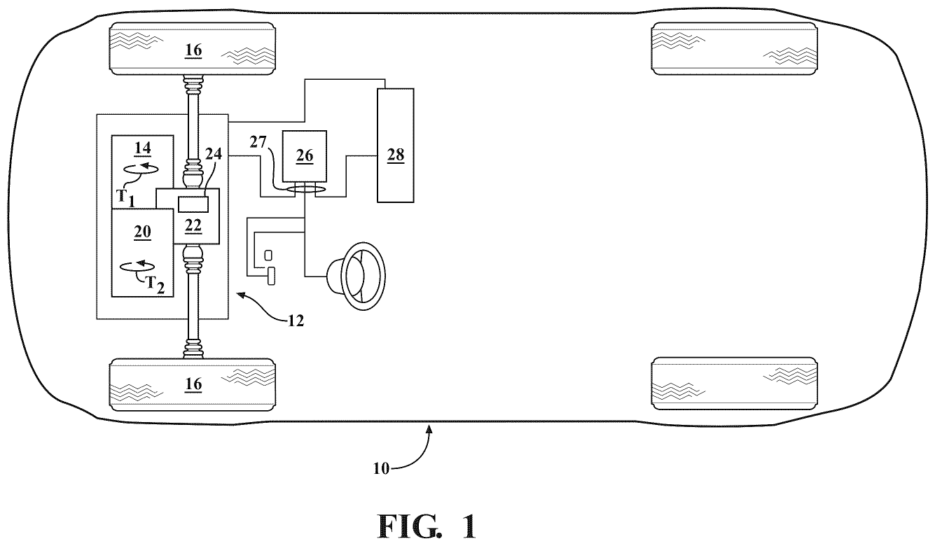

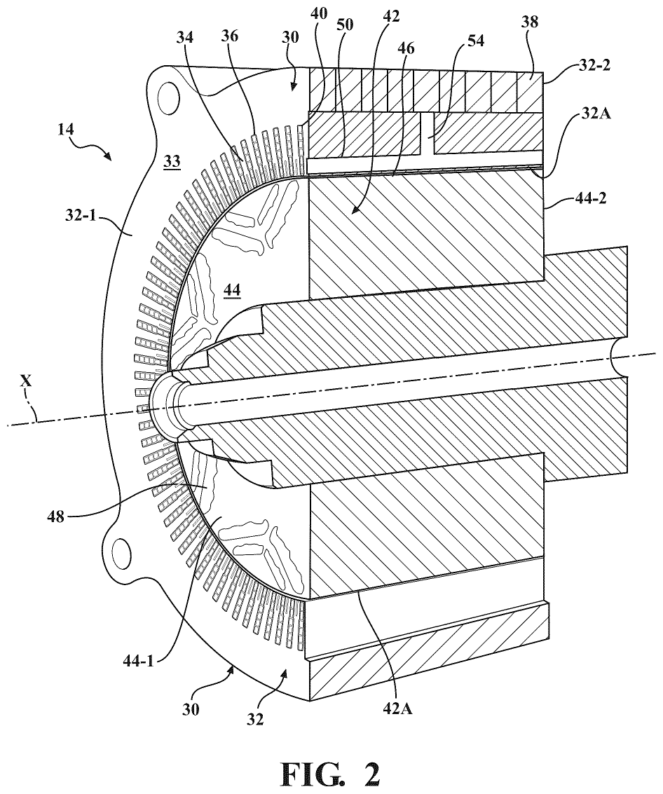

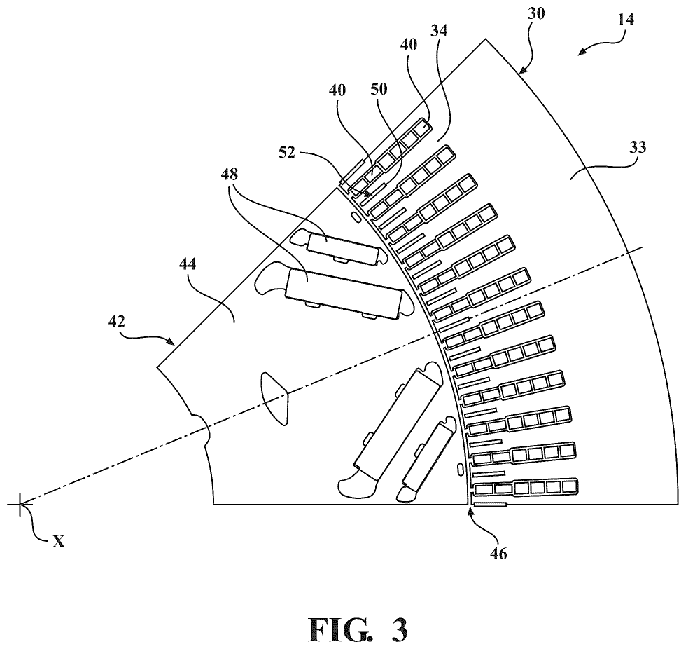

Referring to FIG. 1, a motor vehicle 10 having a powertrain 12 is depicted. The motor vehicle 10 may include, but not be limited to, a commercial vehicle, industrial vehicle, passenger vehicle, aircraft, watercraft, train or the like. It is also contemplated that the motor vehicle 10 may be a mobile platform, such as an airplane, all-terrain vehicle (ATV), boat, personal movement apparatus, robot and the like to accomplish the purposes of this disclosure. The powertrain 12 includes a first power-source 14 depicted as an electric motor-generator and configured to generate a first power-source torque T₁ (shown in FIG. 1) for propulsion of the motor vehicle 10 via driven wheels 16 relative to a road surface. The motor-generator 14 may be configured as a radial flux electric motor (shown for example in FIGS. 2 and 3), where the magnetic flux is generated perpendicular to the motor's axis of rotation and the airgap between the machine's rotor and stator is arranged concentrically with the rotational axis. Alternatively, the motor-generator 14 may be configured an axial flux electric motor (not shown but understood by those skilled in the art) where the magnetic flux is generated coaxially with the motor's axis of rotation and the airgap between the machine's rotor and stator is arranged perpendicular to the rotational axis. For the purposes of compact disclosure, the remainder of present description will focus primarily on the radial flux construction of the motor-generator 14.

As shown in FIG. 1, the powertrain 12 may also include a second power-source 20, such as an internal combustion engine configured to generate a second power-source torque T₂. The power-sources 14 and 20 may act in concert to power the motor vehicle 10 and be operatively connected to a transmission assembly 22. The transmission assembly 22 may be configured to transmit first and/or second power-source torques T₁, T₂ to a final drive unit 24, which in turn may be connected to the driven wheels 16. The first power-source 14, which for the remainder of the present disclosure will be referred to as a motor-generator or electric motor, may, for example, be mounted to the second power-source 20, mounted to (or incorporated into) the transmission assembly 22, mounted to the final drive unit 24, or be a stand-alone assembly mounted to the structure of the vehicle 10. As shown, the motor vehicle 10 additionally includes a programmable electronic controller 26 configured to communicate via a high-voltage BUS 27 and control the powertrain 12 to generate a predetermined amount of power-source torque (such as the sum of T₁ and T₂), and various other vehicle systems. Motor vehicle 10 additionally includes an energy storage system 28, such as one or more batteries, configured to generate and store electrical energy for powering the power-sources 14 and 20.

FIG. 2 illustrates a general cross-section of the radial flux motor-generator 14. As shown, the motor-generator 14 includes a rotationally fixed stator assembly or stator 30 having a generally cylindrical stator core 32 defining a stator core body or back iron 33 and a plurality of stator teeth 34 extending therefrom. The stator core 32 is constructed from a ferromagnetic material and has an external, i.e., radially inner, stator surface 32A, as shown for example in FIG. 2. The stator teeth 34 define multiple conductor slots 36 therebetween. The stator core 32 may include or be constructed from a plurality of adjacent, e.g., bonded, stator laminations 38 arranged along the rotational axis X. As shown in FIG. 2, the stator 30 also includes multiple conductors or windings 40 arranged within the conductor slots 36. Although the stator conductors 40 are generally contained within the conductor slots 36, the end turns of the conductors typically extend beyond the limits of the cylindrical core 32 at axially opposite stator ends-a first end 32-1 and a second end 32-1.

The motor-generator 14 also includes at least one rotor 42 arranged on a shaft defining a rotational axis X and thereby mounted for rotation inside the stator 30. Specifically, the axial flux motor-generator 14 may have two rotors 42, each arranged on one side of the stator 30, while the radial flux motor-generator 14 includes a single rotor 42 mounted inside the corresponding stator 30. The rotor(s) 42 have respective external rotor surface(s) 42A. Each rotor 42 has a ferromagnetic rotor core 44. The rotor core 44 has axially opposite rotor core ends-a first end 44-1 and a second end 44-2. In the case of the radial flux motor-generator 14, the external rotor surface 42A is a radially outer surface, while in the radial flux motor-generator, the external rotor surface 42A is defined by either the first end 44-1 or the second end 44-2.

The rotor core 44 may be constructed from a relatively soft magnetic material, such as laminated silicon or ferrous steel. As shown in FIG. 2, in the radial flux motor-generator 14 the rotor core outer surface 44A establishes an airgap 46 between the rotor 42 and the stator 30, i.e., between the external rotor surface 42A and the external stator surface 32A. Each rotor 42 includes a plurality of magnetic poles 48, with each pole being configured to generate a magnetic flux. The stator conductors 40 are configured to establish a rotating magnetic field exerting a torque on the rotor(s) 42 via interaction with the magnetic poles 48. The stator conductors 40 receive multiphase AC from a power inverter to establish a rotating magnetic field exerting torque upon the rotor(s) 42.

The motor-generator 14 also includes a plurality of first cooling channels 50. In a cross-sectional view shown in FIG. 3, each first cooling channel 50 is defined by a respective stator tooth 34. Each stator tooth 34 may be assembled from the plurality of laminations 38, such that each first cooling channel 50 extends along the rotational axis X. More specifically, as illustrated in the cross-sectional view of FIG. 3, each individual first cooling channel 50 may be arranged entirely within a corresponding tooth 34, such that the first cooling channels do not extend even partially into the back iron 33. Each first cooling channel 50 is configured to receive and pass therethrough a fluid or coolant 52, such as oil, to cool the corresponding stator tooth 34. The first cooling channels 50 may be employed in either the axial flux or in the radial flux motor-generator 14.

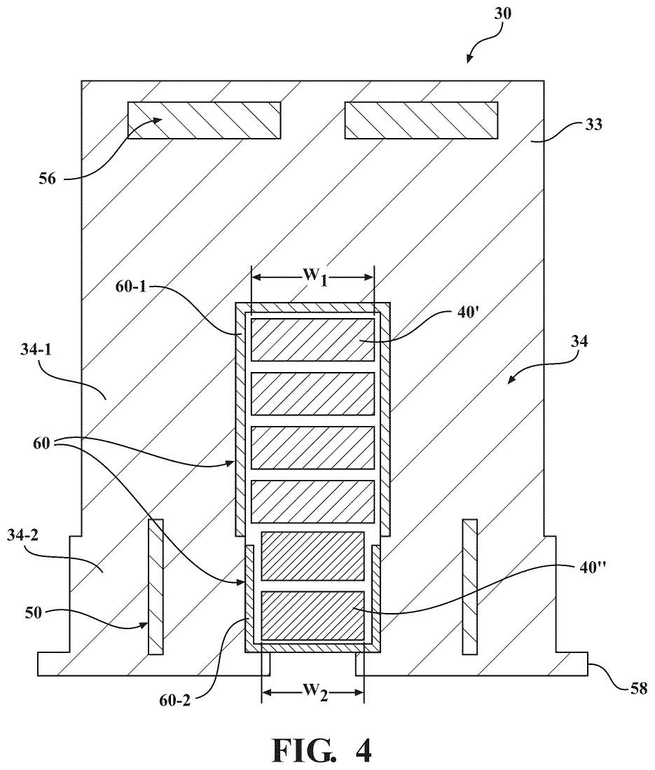

As shown in FIG. 4, the stator 30 may additionally include a plurality of radial cross-channels 54 arranged within the stator core 32 orthogonally to the plurality of first cooling channels 50. Each radial cross-channel 54 is configured to feed the fluid 52 to the respective first cooling channel 50. The stator 30 further includes one or more second cooling channels 56 defined by the stator core body 33. As shown, the second cooling channel(s) 56 may be arranged along the rotational axis X radially outward, i.e., on a larger diameter, with respect to the first cooling channels 50. The second cooling channel(s) 56 are in fluid communication with the radial cross-channels 54. In the cross-sectional view shown in FIG. 4, each stator tooth 34 may include a relatively thinner first section 34-1 projecting directly from the stator core body 33 and a relatively thicker second section 34-2 extending from the first section. As shown, each first cooling channel 50 may be defined by a respective first section of the corresponding stator tooth 34. Each respective first cooling channel 50 may be radially elongated, i.e., being longer radial length than width along the stator circumference, when seen in the cross-sectional view.

With continued reference to FIG. 4, each stator conductor 40′ arranged within a respective conductor slot 36 between corresponding first sections 34-1 of neighboring stator teeth may have a relatively larger width W₁ and each stator conductor 40″ arranged within a respective conductor slot 36 between corresponding second sections 34-2 of neighboring stator teeth may have a relatively smaller width W₂. In such an embodiment, the stator conductors 40′ arranged between the first sections 34-1 and the stator conductors 40″ arranged between the second sections 34-2 of neighboring stator teeth may have different aspect ratios but equivalent cross-sectional areas. Additionally, as shown in FIG. 4, the second section 34-2 of each stator tooth 34 may have a T-shaped end 58 configured to retain respective stator conductors 40 within the corresponding conductor slot 36.

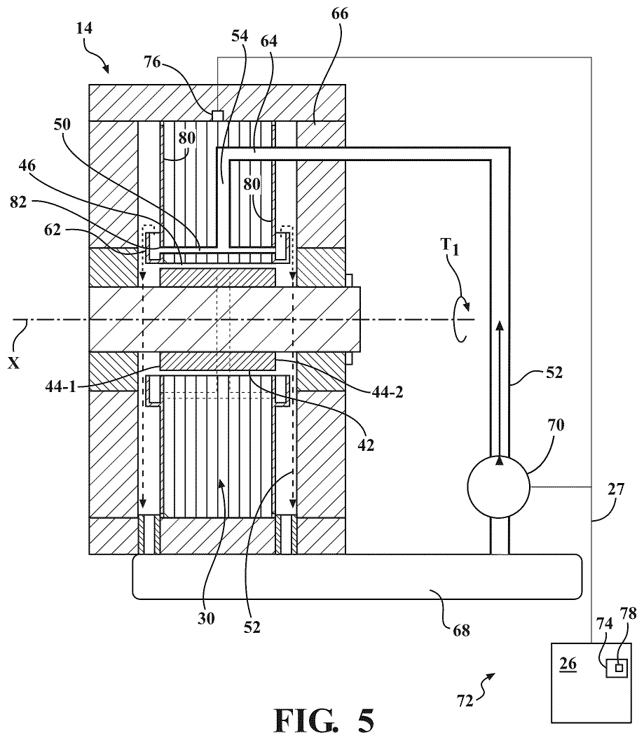

The stator 30 may also include slot liners 60 (shown in FIG. 4) arranged between the conductors 40 and the respective neighboring teeth 34, e.g., to the left and to the right of the respective conductors. The slot liners 60 may have a two-piece construction, including first slot liners 60-1 arranged proximate the first tooth sections 34-1, between the conductors 40 and the back iron 33, and second slot liners 60-2 arranged proximate the second tooth sections 34-2, between the conductors and the first cooling channels 50. The first slot liners 60-1 and the second slot liners 60-2 may be characterized by different thicknesses. Specifically, first slot liners 60-1 may be thicker than the second slot liners 60-2 positioned proximate the first cooling channels 50. As shown in FIG. 5, the electric motor 14 having the radial flux construction may additionally include fluid dam(s) 62 mounted to the radially inner stator surface 32A. The fluid dam(s) 62 are fluidly connected to at least one of the first cooling channels 50. The fluid dam(s) 62 are also configured to direct the fluid 52 exiting the first cooling channel(s) 50 away from the airgap 46. The dam(s) 62 may form fluid reservoirs to accumulate the fluid 52 proximate the stator teeth 34 to maintain cooling thereof.

With reference to FIG. 5, the back iron 33 may define a fluid feed passage 64 in fluid communication with the radial cross-channels 54 and thereby configured to supply the fluid 52 to the first cooling channel(s) 50. As shown, the motor-generator 14 additionally includes a housing 66 defining a fluid sump 68. The fluid sump 68 is configured to collect the coolant 52 after the coolant has passed through the first cooling channel(s) 50, over the fluid dam(s) 60, and was returned by the housing 66 to the fluid sump via gravity or residual fluid pressure. Each of the fluid sump 68 and the fluid feed passage 64 may be in fluid communication with a fluid pump 70 configured to pressurize and circulate the coolant 52, i.e., supply the coolant from the fluid sump 68 to the fluid feed passage. The fluid pump 70 may be part of an electric motor cooling system 72 (shown in FIG. 5) operated via the electronic controller 26 axial flux electric applicable to either the radial flux or the axial flux electric motor-generator 14.

With continued reference to FIG. 5, the electronic controller 26 may be programmed with an algorithm 74 to regulate the fluid pump 70 using detected, such as via corresponding sensors (indicated generally via numeral 76) or calculated variables. Such variables may, for example, be motor phase current, motor rotational speed, temperature of the stator 30, and a flow rate of the coolant 52 in the radial flux electric motor 14. The temperature of the stator 30 may be either detected, otherwise determined, or estimated using recent history of other sensor readings, including that of the liquid temperature, and a motor operational map 78 programmed into the controller 26. The electric motor cooling system 72 may therefore be configured to remove thermal stress and, among multiple benefits, provide longer life under higher speeds or close to peak load for the radial flux electric motor 14, such as during propulsion of the motor vehicle 10.

As shown in FIG. 5, the stator 30 may additionally include endplates 80, one endplate arranged on the first end 32-1 and another on the second end 32-1. The endplates 80 may be configured to target and uniformly distribute the coolant 52 over the end turns of the conductors 40 and/or enhance the heat transfer in the end turns and other eat-sensitive areas of the stator 30. The endplates 80 may include nozzles 82 configured to magnify heat transfer in such thermally sensitive areas. As shown, the nozzles 82 may be configured to direct the coolant 52 flow from the first cooling channels 50 into the fluid dam(s) 62. The endplates 80 may be constructed from additional laminations 38A having a dedicated form or stamping pattern defining the nozzles 82 and each may incorporate a respective fluid dam 62.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings, or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. An electric motor comprising:
a stator having a stator core constructed from a ferromagnetic material and having an external stator surface; wherein:
the stator core includes a stator core body and a plurality of stator teeth extending therefrom; and
the plurality of stator teeth define conductor slots therebetween; and
at least one rotor having an external rotor surface and configured to rotate relative to the stator about a rotational axis, wherein each rotor includes a plurality of magnetic poles;
wherein the stator additionally includes:
a plurality of stator conductors arranged within the conductor slots and configured to establish a rotating magnetic field exerting a torque on the at least one rotor via interaction with the magnetic poles; and
a plurality of first cooling channels, each defined by a respective stator tooth and configured to receive and pass therethrough a fluid to cool the corresponding stator tooth.

2. The electric motor according to claim 1, wherein:
the stator core includes a plurality of adjacent stator laminations arranged along the rotational axis;
each stator tooth is assembled from the plurality of laminations; and
each first cooling channel extends along the rotational axis.

3. The electric motor according to claim 1, wherein the stator additionally includes a plurality of radial cross-channels arranged within the stator core orthogonally to the plurality of first cooling channels, and wherein each of the plurality of radial cross-channels is configured to feed the fluid to a respective first cooling channel.

4. The electric motor according to claim 3, wherein the stator additionally includes at least one second cooling channel defined by the stator core body, arranged along the rotational axis radially outward with respect to the plurality of first cooling channels, and in fluid communication with the plurality of radial cross-channels.

5. The electric motor according to claim 1, wherein, in a cross-sectional view, each stator tooth includes a relatively thinner first section projecting directly from the stator core body and a relatively thicker second section extending from the first section, and wherein each first cooling channel is defined by a respective first section of the corresponding stator tooth.

6. The electric motor according to claim 5, wherein each stator conductor arranged within a respective conductor slot between corresponding first sections of neighboring stator teeth has a relatively larger width and each stator conductor arranged within a respective conductor slot between corresponding second sections of neighboring stator teeth has a relatively smaller width.

7. The electric motor according to claim 6, wherein the stator conductors arranged between the first sections and the stator conductors arranged between the second sections of neighboring stator teeth have different aspect ratios but equivalent cross-sectional areas.

8. The electric motor according to claim 6, wherein the second section of each stator tooth has a T-shaped end configured to retain respective stator conductors within the corresponding conductor slot.

9. The electric motor according to claim 1, wherein:
the electric motor has a radial flux construction such that the at least one rotor is a single rotor mounted inside the stator;
the external stator surface stator is a radially inner stator surface;
the external rotor surface is a radially outer rotor surface; and
an airgap is established between the radially inner stator surface and the radially outer rotor surface.

10. The electric motor according to claim 9, further comprising a fluid dam mounted to the radially inner stator surface, fluidly connected to at least one of the plurality of first cooling channels, and configured to direct the fluid exiting the at least one of the plurality of first cooling channels away from the airgap.

11. A motor vehicle comprising:
an electric motor configured to generate torque for propulsion of the motor vehicle, the electric motor including:
a stator having a stator core constructed from a ferromagnetic material and having an external stator surface; wherein:
the stator core includes a stator core body and a plurality of stator teeth extending therefrom; and
the plurality of stator teeth define conductor slots therebetween; and
at least one rotor having an external rotor surface and configured to rotate relative to the stator about a rotational axis, wherein each rotor includes a plurality of magnetic poles;
wherein the stator additionally includes:
a plurality of stator conductors arranged within the conductor slots and configured to establish a rotating magnetic field exerting a torque on the at least one rotor via interaction with the magnetic poles; and
a plurality of first cooling channels, each defined by a respective stator tooth and configured to receive and pass therethrough a fluid to cool the corresponding stator tooth.

12. The motor vehicle according to claim 11, wherein the stator core includes a plurality of adjacent stator laminations arranged along the rotational axis;
each stator tooth is assembled from the plurality of laminations; and
each first cooling channel extends along the rotational axis.

13. The motor vehicle according to claim 11, wherein the stator additionally includes a plurality of radial cross-channels arranged within the stator core orthogonally to the plurality of first cooling channels, and wherein each of the plurality of radial cross-channels is configured to feed the fluid to a respective first cooling channel.

14. The motor vehicle according to claim 13, wherein the stator additionally includes at least one second cooling channel defined by the stator core body, arranged along the rotational axis radially outward with respect to the plurality of first cooling channels, and in fluid communication with the plurality of radial cross-channels.

15. The motor vehicle according to claim 11, wherein, in a cross-sectional view, each stator tooth includes a relatively thinner first section projecting directly from the stator core body and a relatively thicker second section extending from the first section, and wherein each first cooling channel is defined by a respective first section of the corresponding stator tooth.

16. The motor vehicle according to claim 15, wherein each stator conductor arranged within a respective conductor slot between corresponding first sections of neighboring stator teeth has a relatively larger width and each stator conductor arranged within a respective conductor slot between corresponding second sections of neighboring stator teeth has a relatively smaller width.

17. The motor vehicle according to claim 16, wherein the stator conductors arranged between the first sections and the stator conductors arranged between the second sections of neighboring stator teeth have different aspect ratios but equivalent cross-sectional areas.

18. The motor vehicle according to claim 16, wherein the second section of each stator tooth has a T-shaped end configured to retain respective stator conductors within the corresponding conductor slot.

19. The motor vehicle according to claim 11, wherein:
the electric motor has a radial flux construction and the at least one rotor is a single rotor mounted inside the stator;
the external stator surface stator is a radially inner stator surface;
the external rotor surface is a radially outer rotor surface; and
an airgap is established between the radially inner stator surface and the radially outer rotor surface; and
the electric motor additionally includes a fluid dam mounted to the radially inner stator surface, fluidly connected to at least one of the plurality of first cooling channels, and configured to direct the fluid exiting the at least one of the plurality of first cooling channels away from the airgap.

20. A radial flux electric motor comprising:
a stator having a stator core constructed from a ferromagnetic material and having a radially inner stator surface; wherein:
the stator core includes a stator core body and a plurality of stator teeth extending therefrom; and
the plurality of stator teeth define conductor slots therebetween; and
a rotor mounted inside the stator and having a radially outer rotor surface and configured to rotate relative to the stator about a rotational axis, wherein the rotor includes a plurality of magnetic poles, and wherein an airgap is established between the radially outer rotor surface and the radially inner stator surface;
wherein the stator additionally includes:
a plurality of stator conductors arranged within the conductor slots and configured to establish a rotating magnetic field exerting a torque on the at least one rotor via interaction with the magnetic poles; and
a plurality of first cooling channels, each defined by a respective stator tooth and configured to receive and pass therethrough a fluid to cool the corresponding stator tooth; and
a fluid dam mounted to the radially inner stator surface, fluidly connected to the plurality of first cooling channels, and configured to direct the fluid exiting the plurality of first cooling channels away from the airgap.
